(19) United States
(12) Patent Application Publication
(10) Pub. No.: US 2022/0351210 A1
(43) Pub. Date: Nov. 3, 2022

(54) METHOD AND SYSTEM FOR DETECTION OF ABNORMAL TRANSACTIONAL BEHAVIOR

(71) Applicant: JPMorgan Chase Bank, N.A., New York, NY (US)

(72) Inventors: Keshav RAMANI, Jersey City, NJ (US); Daniel BORRAJO, Pozuelo de Alarcon (ES); Sameena SHAH, Scarsdale, NY (US)

(73) Assignee: JPMorgan Chase Bank, N.A., New York, NY (US)

(21) Appl. No.: 17/596,034

(22) PCT Filed: Mar. 22, 2021
(86) PCT No.: PCT/US2021/023471

§ 371 Date: Dec. 2, 2021

(51) Int. Cl. G06Q 20/40

(52) U.S. Cl. CPC G06Q 20/4016

(57) ABSTRACT

A method for detecting abnormal transactional behavior in a financial account is provided. The method includes: accessing first information that includes a textual description of a first transaction of a plurality of transactions associated with a first account; analyzing the text by applying tags thereto; assigning, based on a result of the analyzing, the first transaction to a respective cluster of the plurality of transactions; and designating each respective cluster as corresponding to one from among a normal transactional behavior group, an abnormal transactional behavior group, and an anomalous transactional behavior group. When a proportion of abnormal and anomalous transactions exceeds a threshold, the account may be flagged for further investigation.

### BACKGROUND

### 1. Field of the Disclosure

This technology generally relates to methods and systems for detecting abnormal transactional behavior in banking accounts.

### 2. Background Information

In a financial institution, such as a bank, a typical client has a set of accounts. Every type of account is expected to have a certain type of transactional behavior. In this regard, deviations from these expectations may present financial risks to the institution.

Transactional abnormalities may occur when an account executes a set of transactions that deviates from its historical activity, or when an account behaves differently than its peers or its account type. The following are examples of transactional abnormalities: 1) Historical: Account X has only been used for paying rent and tax and receiving salary for the past three years, but suddenly, a huge sum of money is received from a country that is the subject of sanctions from the United States (US) Office of Foreign Assets Control (OFAC). 2) Industry-specific: Account Y is owned by a private investment company—however, its transactions are unlike transactions of other investment companies, which are strictly investment related; by contrast, account Y has a significant number of operating company-like transactions.

Accordingly, there is a need for an automated system and method for identifying such abnormalities in transactional behavior of accounts by ingesting and processing various risk indicators.

### SUMMARY

The present disclosure, through one or more of its various aspects, embodiments, and/or specific features or sub-components, provides, inter alia, various systems, servers, devices, methods, media, programs, and platforms for detecting abnormal transactional behavior in banking accounts.

According to an aspect of the present disclosure, a method for detecting abnormal transactional behavior in a financial account is provided. The method is implemented by at least one processor. The method includes: accessing, by the at least one processor, first information that relates to a first transaction of a plurality of transactions associated with a first account, the first information including text that describes the first transaction; analyzing, by the at least one processor, the text; assigning, by the at least one processor based on a result of the analyzing, the first transaction to a respective subset of the plurality of transactions; and designating, by the at least one processor, each respective subset as corresponding to one from among a normal transactional behavior group, an abnormal transactional behavior group, and an anomalous transactional behavior group.

The method may further include assigning each transaction included in the plurality of transactions to exactly one respective subset within the plurality of transactions.

The analyzing may include: determining whether at least one tag from among a predetermined plurality of tags is applicable to the text; when a determination is made that at least one tag is applicable, applying the at least one tag to the first transaction and outputting, as a result of the analyzing, the applied at least one tag in association with the first transaction; and when a determination is made that no tag within the predetermined plurality of tags is applicable, outputting, as a result of the analyzing, the text in association with the first transaction.

The applying of the at least one tag may include using fuzzy string matching to apply the at least one tag.

The assigning may include: accessing second information that relates to a second transaction of the plurality of transactions associated with the first account, the second information including text that describes the second transaction: measuring a distance between the first information and the second information: and assigning the first transaction to the respective subset by applying a clustering model that uses respective distances between corresponding pairs of transactions from among the plurality of transactions as inputs.

The measuring of the distance may include: determining, for at least one from among the applied at least one tag and the text associated with the first transaction, a first set of term frequency-inverse document frequency (TF-IDF) vectors; determining, for the second information, a second set of TF-IDF vectors; and calculating a cosine distance between the first set of TF-IDF vectors and the second set of TF-IDF vectors.

The measuring of the distance may include: extracting, from the first information, a first set of features that includes at least one from among a numeric feature, a categorical feature, and a Boolean feature; extracting, from the second information, a second set of features that includes at least one from among a numeric feature, a categorical feature, and a Boolean feature; and calculating a Gower's distance value between the first set of features and the second set of features.

The clustering model may include a density-based spatial clustering of applications with noise (DBSCAN) model.

The method may further include: determining a total number of transactions within the plurality of transactions; determining a first number of transactions that are assigned to a subset designated as corresponding to the abnormal transactional behavior group; determining a second number of transactions that are assigned to a subset designated as corresponding to the anomalous transactional behavior group; calculating a proportion of a sum of the first number and the second number with respect to the total number of transactions; and when the calculated proportion exceeds a predetermined threshold, transmitting a notification message to a user to indicate that a transaction history of the first account requires investigation. The predetermined threshold may be 10%.

According to another exemplary embodiment, a computing apparatus for detecting abnormal transactional behavior in a financial account is provided. The computing apparatus includes a processor; a memory; and a communication interface coupled to each of the processor and the memory. The processor is configured to: access first information that relates to a first transaction of a plurality of transactions associated with a first account, the first information including text that describes the first transaction; analyze the text; assign, based on a result of the analysis, the first transaction to a respective subset of the plurality of transactions; and designate each respective subset as corresponding to one from among a normal transactional behavior group, an abnormal transactional behavior group, and an anomalous transactional behavior group.

The processor may be further configured to assign each transaction included in the plurality of transactions to exactly one respective subset within the plurality of transactions.

The processor may be further configured to analyze the text by: determining whether at least one tag from among a predetermined plurality of tags is applicable to the text; when a determination is made that at least one tag is applicable, applying the at least one tag to the first transaction and outputting, as a result of the analysis, the applied at least one tag in association with the first transaction; and when a determination is made that no tag within the predetermined plurality of tags is applicable, outputting, as a result of the analysis, the text in association with the first transaction.

The processor may be further configured to use fuzzy string matching to apply the at least one tag.

The processor may be further configured to perform the assigning by: accessing second information that relates to a second transaction of the plurality of transactions associated with the first account, the second information including text that describes the second transaction: measuring a distance between the first information and the second information; and assigning the first transaction to the respective subset by applying a clustering model that uses respective distances between corresponding pairs of transactions from among the plurality of transactions as inputs.

The processor may be further configured to measure the distance by: determining, for at least one from among the applied at least one tag and the text associated with the first transaction, a first set of term frequency-inverse document frequency (TF-IDF) vectors; determining, for the second information, a second set of TF-IDF vectors; and calculating a cosine distance between the first set of TF-IDF vectors and the second set of TF-IDF vectors.

The processor may be further configured to measure the distance by: extracting, from the first information, a first set of features that includes at least one from among a numeric feature, a categorical feature, and a Boolean feature; extracting, from the second information, a second set of features that includes at least one from among a numeric feature, a categorical feature, and a Boolean feature; and calculating a Gower's distance value between the first set of features and the second set of features.

The clustering model may include a density-based spatial clustering of applications with noise (DBSCAN) model.

The processor may be further configured to: determine a total number of transactions within the plurality of transactions; determine a first number of transactions that are assigned to a subset designated as corresponding to the abnormal transactional behavior group; determine a second number of transactions that are assigned to a subset designated as corresponding to the anomalous transactional behavior group; calculate a proportion of a sum of the first number and the second number with respect to the total number of transactions; and when the calculated proportion exceeds a predetermined threshold, transmit, via the communication interface, a notification message to a user to indicate that a transaction history of the first account requires investigation. The predetermined threshold may be 10%.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for detecting abnormal transactional behavior in banking accounts.

FIG. 4 is a flowchart of an exemplary process for implementing a method for detecting abnormal transactional behavior in banking accounts.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

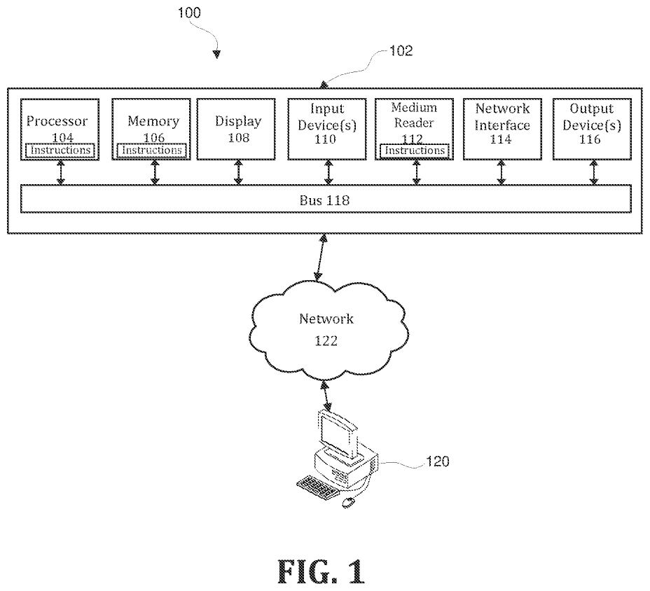

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for detecting abnormal transactional behavior in banking accounts.

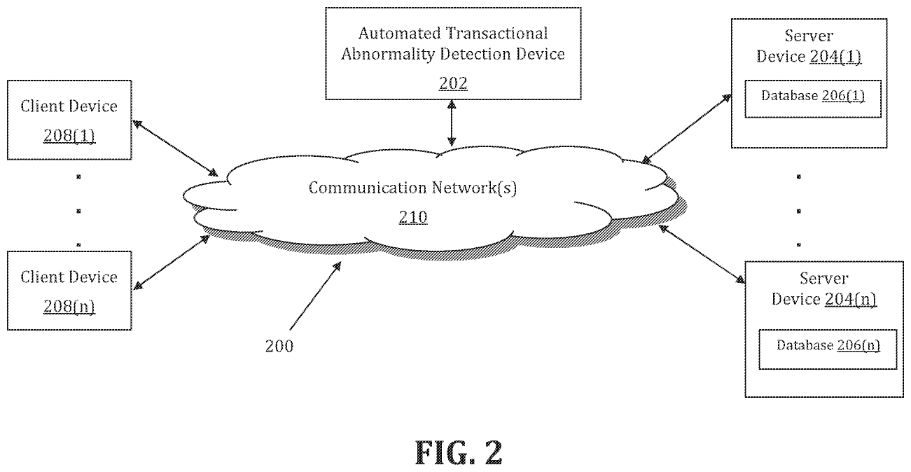

Referring to FIG. 2, a schematic of an exemplary network environment 200 for implementing a method for detecting abnormal transactional behavior in banking accounts is illustrated. In an exemplary embodiment, the method is executable on any networked computer platform, such as, for example, a personal computer (PC).

The method for detecting abnormal transactional behavior in banking accounts may be implemented by an Automated Transactional Abnormality Detection (ATAD) device 202. The ATAD device 202 may be the same or similar to the computer system 102 as described with respect to FIG. 1. The ATAD device 202 may store one or more applications that can include executable instructions that, when executed by the ATAD device 202, cause the ATAD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ATAD device 202 itself, may be located in virtual server(s) running in a cloud-based computing environment rather than being tied to one or more specific physical network computing devices. Also, the application(s) may be running in one or more virtual machines (VMs) executing on the ATAD device 202. Additionally, in one or more embodiments of this technology, virtual machine(s) running on the ATAD device 202 may be managed or supervised by a hypervisor.

In the network environment 200 of FIG. 2, the ATAD device 202 is coupled to a plurality of server devices 204(1)-204(n) that hosts a plurality of databases 206(1)-206(n), and also to a plurality of client devices 208(1)-208(n) via communication network(s) 210. A communication interface of the ATAD device 202, such as the network interface 114 of the computer system 102 of FIG. 1, operatively couples and communicates between the ATAD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATAD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ATAD devices that efficiently implement a method for detecting abnormal transactional behavior in banking accounts.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ATAD device 202 may be a standalone device or integrated with one or more other devices or apparatuses, such as one or more of the server devices 204(1)-204(n), for example. In one particular example, the ATAD device 202 may include or be hosted by one of the server devices 204(1)-204(n), and other arrangements are also possible. Moreover, one or more of the devices of the ATAD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ATAD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to industry-specific transactional norms and historical account-specific transactional behavior.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ATAD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ATAD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ATAD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ATAD device 202, the server devices 204(1)-204(n), or the client devices 208(1)-208(n), for example, may be configured to operate as virtual instances on the same physical machine. In other words, one or more of the ATAD device 202, the server devices 204(1)-204(n), or the client devices 208(1)-208(n) may operate on the same physical device rather than as separate devices communicating through communication network(s) 210. Additionally, there may be more or fewer ATAD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

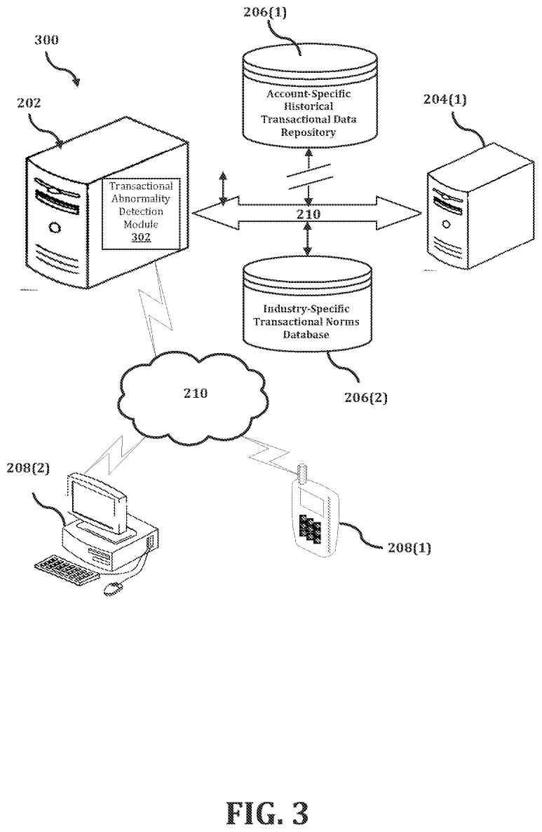

The ATAD device 202 is described and illustrated in FIG. 3 as including a transactional abnormality detection module 302, although it may include other rules, policies, modules, databases, or applications, for example. As will be described below, the transactional abnormality detection module 302 is configured to implement a method for detecting abnormal transactional behavior in banking accounts.

An exemplary process 300 for implementing a mechanism for detecting abnormal transactional behavior in banking accounts by utilizing the network environment of FIG. 2 is illustrated as being executed in FIG. 3. Specifically, a first client device 208(1) and a second client device 208(2) are illustrated as being in communication with ATAD device 202. In this regard, the first client device 208(1) and the second client device 208(2) may be “clients” of the ATAD device 202 and are described herein as such. Nevertheless, it is to be known and understood that the first client device 208(1) and/or the second client device 208(2) need not necessarily be “clients” of the ATAD device 202, or any entity described in association therewith herein. Any additional or alternative relationship may exist between either or both of the first client device 208(1) and the second client device 208(2) and the ATAD device 202, or no relationship may exist.

Further, ATAD device 202 is illustrated as being able to access an account-specific historical transactional behavior data repository 206(1) and an industry-specific transactional norms database 206(2). The transactional abnormality detection module 302 may be configured to access these databases for implementing a method for detecting abnormal transactional behavior in banking accounts.

The first client device 208(1) may be, for example, a smart phone. Of course, the first client device 208(1) may be any additional device described herein. The second client device 208(2) may be, for example, a personal computer (PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ATAD device 202 via broadband or cellular communication. Of course, these embodiments are merely exemplary and are not limiting or exhaustive.

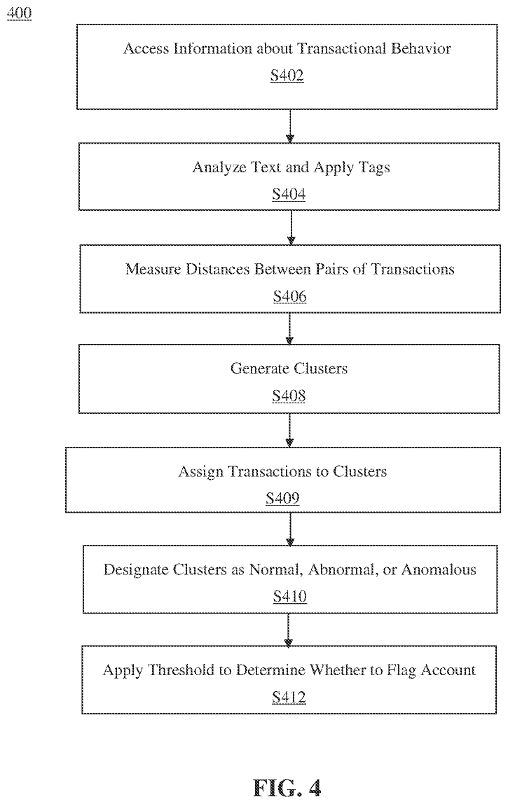

Upon being started, the transactional abnormality detection module 302 executes a process for detecting abnormal transactional behavior in banking accounts. An exemplary process for detecting abnormal transactional behavior in banking accounts is generally indicated at flowchart 400 in FIG. 4.

In process 400 of FIG. 4, at step S402, the transactional abnormality detection module 302 accesses information that relates to a first transaction from among a plurality of transactions associated with a particular financial account. In an exemplary embodiment, the information includes text that describes the first transaction. The information may further include any one of more of a numeric feature, a categorical feature, and a Boolean feature.

At step S404, the transactional abnormality detection module 302 analyzes the text accessed in step S402. In an exemplary embodiment, the analysis of the text is implemented by applying one or more tags to the first transaction. The tags may be included in a predetermined list of tags. In an exemplary embodiment, the transactional abnormality detection module 302 determines whether any of the tags included in the predetermined list of tags is applicable to the first transaction, and when at least one tag is determined as being applicable, the applied tag is outputted in association with the first transaction as a result of the analysis. When a determination is made that none of the tags included in the predetermined list is applicable, the text remains intact and is then outputted in association with the first transaction as a result of the analysis. In an exemplary embodiment, the transactional abnormality detection module 302 may use fuzzy string matching to apply the tag(s).

In step S406, the transactional abnormality detection module 302 measures a distance between the first transaction and a second transaction from among the plurality of transactions that is associated with the particular financial account. In step S408, the transactional abnormality detection module 302 generates a set of clusters based on regions of high density with respect to pairwise distances among the plurality of transactions, and then, in step S409, the transactional abnormality detection module 302 assigns the first transaction to a respective cluster from among the set of clusters. In an exemplary embodiment, a large number of transactions that are included in the plurality of transactions have previously been assigned to a cluster, and the transactional abnormality detection module may repeat step S406 by measuring a respective distance between the first transaction and each of several other transactions included in the plurality of transactions, and then, in step S409, the transactional abnormality detection module 302 uses the measured distances to determine which cluster is the best fit for the first transaction. In an exemplary embodiment, each of the plurality of transactions is assigned to exactly one cluster, and the number of transactions is relatively large, such as, for example, at least ten thousand (10,000) transactions.

In an exemplary embodiment, the distance may be measured by using a Natural Language Processing (NLP) technique with respect to the text included in the information accessed in step S402 and/or the tag(s) applied in step S404. For example, the text and/or tag(s) may be vectorized by determining a set of term frequency-inverse document frequency (TF-IDF) vectors for the first transaction, and a similar operation may be performed to determine a set of TF-IDF vectors for the second transaction, and for any number of additional transactions. Then, the distance between the first transaction and any other transaction may be measured by calculating a cosine distance between the two sets of TF-IDF vectors.

In an exemplary embodiment, a distance may also be measured by extracting any one or more of a numeric feature, a categorical feature, and a Boolean feature from the information accessed in step S402 with respect to the first transaction, and then extracting similar features from corresponding information from the second transaction and/or any other transaction. The distance may then be measured by calculating a Gower's distance value between the extracted features of the first transaction and any other transaction.

Further, the distance may be calculated by combining the measured cosine distance and the measured Gower's distance. For example, a mathematical expression that includes both distances as components thereof may be applied.

In an exemplary embodiment, the determination of which cluster is the best fit for the first transaction may be implemented by applying a clustering model that uses the calculated distances between respective pairs of transactions as inputs. For example, a density-based spatial clustering of applications with noise (DBSCAN) model may be applied.

At step S410, the transactional abnormality detection module 302 designates each cluster as belonging to one of three groups. The first group includes clusters that correspond to normal transactional behavior. The second group includes clusters that correspond to abnormal transactional behavior. The third group includes clusters that correspond to anomalous transactional behavior, i.e., behavior that cannot easily be recognized as either normal or abnormal.

Then, at step S412, the transactional abnormality detection module 302 applies a predetermined threshold to a proportion of the total number of transactions that are in either the second group (i.e., abnormal behavior) or the third group (i.e., anomalous behavior), and when the proportion exceeds the threshold, the account may be flagged for investigation. In an exemplary embodiment, the threshold may be 10%. Thus, in a scenario in which the total number of transactions associated with a particular account is 30,000 and the transactional abnormality detection module 302 has assigned more than 3000 transactions to clusters that are designated as abnormal or anomalous, then the account may be flagged for investigation, based on a threshold of 10%.

Abnormal behavior is generally defined with respect to a notion of normal behavior. Thus, in an exemplary embodiment, a method for detecting abnormal transactional behavior in banking accounts includes defining a set of transactions based on notions of expected behavior and then learning the deviations. A notion of a “normal” sample varies based on the use case. For example, when performing abnormality detection within transactions of a single account, notions of normal behavior are learned with respect to the banking account's own historical transactions. However, when performing abnormality detection across a specific type of industry, the cohort now becomes a sample of transactions across multiple company accounts.

In an exemplary embodiment, a method for detecting abnormal transactional behavior in banking accounts implements an algorithm that performs the following four steps. First, the algorithm performs pre-processing steps to remove noise and other inadvertent artifacts from the transactions. Second, for each transaction, the algorithm assigns a tag that is indicative of the type of the transaction and/or the purpose of the transaction. A predetermined list of tags may be provided as an input to the algorithm for this function. Third, commonly occurring clusters of transactions are demarcated by making use of a density based clustering model. Finally, these clusters are annotated by a human investigator as either expected or not expected.

Any transaction that does not fall into these two categories is identified by the algorithm as anomalous. Once the above steps conclude, the algorithm processes any banking account's transactions. If the algorithm determines that a certain percentage or magnitude of anomaly in one or more of the transactions that are either not expected or anomalous, the algorithm recommends that an investigator probe further into this account.

In an exemplary embodiment, a method for detecting abnormal transactional behavior in banking accounts implements an artificial intelligence (AI)-based framework that makes use of various techniques, such as Density Based Clustering and Natural Language Processing, to achieve the goal of operating behavior detection.

First, the variance in the multitude of transactions is addressed by applying Natural Language Processing to tag every transaction. In an exemplary embodiment, fuzzy string matching is employed to assign curated tags to every transaction.

Second, based on these tags and other transaction features, the transactions are clustered in order to identify naturally occurring groups or themes of transactions.

Third, each theme of transactions is assigned to one of three categories, which correspond to normal, abnormal, and anomalous. For example, when normal corresponds to a portfolio investment company (PIC) and abnormal corresponds to an operating company (OPCO), the three categories may include “PIC-like”, “OPCO-like”, and “unresolved”. Then, a simple thresholding rule is applied in order to determine that if any account has more than a predetermined percentage (e.g., 10%) of its transactions falling into either the “OPCO Like” category or the unresolved category, then the account is flagged as an account that must be reviewed.

In order to develop well generalized clusters, an initial random sample of 10,000 transactions from accounts that declare themselves to be PICs is used. This sample provides a generic view of all of the kinds of transactions present within the industry-specific transactional norms database 206(2).

Step 1—Transaction Tagging: Some of the information used to analyze behavior takes the form of text. Initially, the raw text may be vectorized using a character level term frequency-inverse document frequency (TF-IDF) vectorizer that works at the unigram, bigram and trigram levels. However, it was found that the text fields had a great level of variance due to formatting issues.

When the textual features pass through the aforementioned vectorizer, it may become difficult for strings that represent similar entities to have similar vector representations. The formatting difference between them tends to manifest even in their representations. For example, a misplaced space may be sufficient to completely throw the vectorizer off and create issues.

In order to address this problem, a fuzzy string matching algorithm may be employed to convert the raw text into a predetermined list of tags which are intended to represent the theme of the transaction and to indicate the purpose of the transaction.

In an exemplary embodiment, not all transactions will be assigned one of these tags. For example, when a transaction does not appear to be similar to any of the tags included in the predetermined list, such a transaction may simply retain its original text in lieu of receiving an assigned tag.

Step 2—Clustering Transactions: Once a cleaned set of transactions with some transactions having a tag associated with them is generated, then the next step is to cluster these transactions. As is the case with every clustering problem, an appropriate distance measure and model must be selected for this task.

Distance Measure: Inherently, the problem at hand has a multitude of features that are relevant. However, it is not the case that all of these features could be of the same data type, and therefore, a distance metric that can be used for mixed data type tasks must be used.

In an exemplary embodiment, there are fundamentally three different types of features that are considered: 1) numeric features; 2) categorical features; and 3) Boolean features. Further, some of the numerical features are also based on the text associated with every transaction (i.e., either as a tag or as transaction text). Therefore, the distance measure may include a combination of Cosine Distance, which is used for the TF-IDF vectors used to represent the text, and Gower's Distance, which is used for other categorical and numerical data. Mathematically, the distance measure may be represented as follows;
Given two transactions (t₁, t₂), the distance between them is defined as:

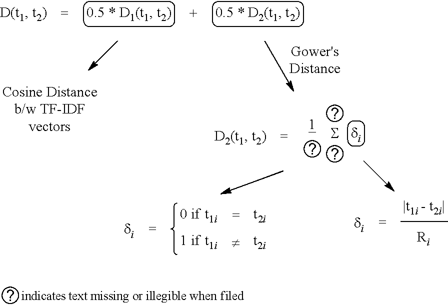

Clustering Model: Another important aspect of the clustering framework is the clustering model. While it is commonplace to use K-Means for most clustering frameworks, K-Means is an algorithm that is designed to work with the family of euclidean distance metrics, and because the distance measure discussed above is a customized distance measure, K-Means and its associated family of models might not be the best option. Further, the notion of frequently occurring transactions is central to the method for detecting abnormal transactional behavior in banking accounts in accordance with an exemplary embodiment, and therefore, a model that clusters based on the density of examples may be most suitable.

In an exemplary embodiment, a density-based spatial clustering of applications with noise (DBSCAN) model may be used. The DBSCAN model is a density based model that also allows for every point to be non-conforming to any cluster. This type of model conveniently suits the problem definition, as there will always be a few unresolved, esoteric transactions that do not fall into any broad category.

As a result, the clustering model outputs high density clusters, as well as points that seem to be noisy (i.e., not conforming to any cluster). Hyperparameters may be tuned to optimize the silhouette coefficient to ensure that high quality clusters are generated by the model.

Step 3—Labelling Clusters: In an exemplary embodiment, the clusters of transactions generated in step 2 may be analyzed by investigators for sanity. Based on their feedback, more tags may be added to the list, and some tags may be removed, so as to capture any remaining clusters of transactions or outliers. In an exemplary embodiment, all of the generated clusters are labeled into one of three categories: “PIC like”, “OPCO like”, and “unresolved”. Thus, when provided with a transaction, the method for detecting abnormal transactional behavior in banking accounts results in a determination that the said transaction is labeled into one of the three aforementioned categories.

As each transaction may be labeled into a risk category, a threshold is chosen for the allowable number of transactions in an account falling into either of the “OPCO like” category or the “unresolved” category. In an exemplary embodiment, the threshold may be 10%. In this regard, if an account has >10% of its transactions over its entire history falling into either of the two categories, then the account is flagged for further investigation.

Accordingly, with this technology, an optimized process for detecting abnormal transactional behavior in banking accounts is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detecting abnormal transactional behavior in a financial account, the method being implemented by at least one processor, the method comprising:
accessing, by the at least one processor, first information that relates to a first transaction of a plurality of transactions associated with a first account, the first information including text that describes the first transaction;
analyzing, by the at least one processor, the text;
assigning, by the at least one processor based on a result of the analyzing, the first transaction to a respective subset of the plurality of transactions; and
designating, by the at least one processor, each respective subset as corresponding to one from among a normal transactional behavior group, an abnormal transactional behavior group, and an anomalous transactional behavior group.

2. The method of claim 1, further comprising assigning each transaction included in the plurality of transactions to exactly one respective subset within the plurality of transactions.

3. The method of claim 1, wherein the analyzing comprises:
determining whether at least one tag from among a predetermined plurality of tags is applicable to the text;
when a determination is made that at least one tag is applicable, applying the at least one tag to the first transaction and outputting, as a result of the analyzing, the applied at least one tag in association with the first transaction; and
when a determination is made that no tag within the predetermined plurality of tags is applicable, outputting, as a result of the analyzing, the text in association with the first transaction.

4. The method of claim 3, wherein the applying of the at least one tag comprises using fuzzy string matching to apply the at least one tag.

5. The method of claim 3, wherein the assigning comprises:
accessing second information that relates to a second transaction of the plurality of transactions associated with the first account, the second information including text that describes the second transaction;
measuring a distance between the first information and the second information; and
assigning the first transaction to the respective subset by applying a clustering model that uses respective distances between corresponding pairs of transactions from among the plurality of transactions as inputs.

6. The method of claim 5, wherein the measuring of the distance comprises:
determining, for at least one from among the applied at least one tag and the text associated with the first transaction, a first set of term frequency-inverse document frequency (TF-IDF) vectors;
determining, for the second information, a second set of TF-IDF vectors; and
calculating a cosine distance between the first set of TF-IDF vectors and the second set of TF-IDF vectors.

7. The method of claim 5, wherein the measuring of the distance comprises:
extracting, from the first information, a first set of features that includes at least one from among a numeric feature, a categorical feature, and a Boolean feature;
extracting, from the second information, a second set of features that includes at least one from among a numeric feature, a categorical feature, and a Boolean feature; and
calculating a Gower's distance value between the first set of features and the second set of features.

8. The method of claim 3, wherein the clustering model includes a density-based spatial clustering of applications with noise (DBSCAN) model.

9. The method of claim 1, further comprising:
determining a total number of transactions within the plurality of transactions;
determining a first number of transactions that are assigned to a subset designated as corresponding to the abnormal transactional behavior group;
determining a second number of transactions that are assigned to a subset designated as corresponding to the anomalous transactional behavior group;
calculating a proportion of a sum of the first number and the second number with respect to the total number of transactions; and
when the calculated proportion exceeds a predetermined threshold, transmitting a notification message to a user to indicate that a transaction history of the first account requires investigation.

10. The method of claim 9, wherein the predetermined threshold is 10%.

11. A computing apparatus for detecting abnormal transactional behavior in a financial account, the computing apparatus comprising:
a processor;
a memory; and
a communication interface coupled to each of the processor and the memory,
wherein the processor is configured to:
access first information that relates to a first transaction of a plurality of transactions associated with a first account, the first information including text that describes the first transaction;
analyze the text;
assign, based on a result of the analysis, the first transaction to a respective subset of the plurality of transactions; and
designate each respective subset as corresponding to one from among a normal transactional behavior group, an abnormal transactional behavior group, and an anomalous transactional behavior group.

12. The computing apparatus of claim 11, wherein the processor is further configured to assign each transaction included in the plurality of transactions to exactly one respective subset within the plurality of transactions.

13. The computing apparatus of claim 11, wherein the processor is further configured to analyze the text by:
determining whether at least one tag from among a predetermined plurality of tags is applicable to the text;
when a determination is made that at least one tag is applicable, applying the at least one tag to the first transaction and outputting, as a result of the analysis, the applied at least one tag in association with the first transaction; and
when a determination is made that no tag within the predetermined plurality of tags is applicable, outputting, as a result of the analysis, the text in association with the first transaction.

14. The computing apparatus of claim 13, wherein the processor is further configured to use fuzzy string matching to apply the at least one tag.

15. The computing apparatus of claim 13, wherein the processor is further configured to perform the assigning by:
accessing second information that relates to a second transaction of the plurality of transactions associated with the first account, the second information including text that describes the second transaction;
measuring a distance between the first information and the second information; and
assigning the first transaction to the respective subset by applying a clustering model that uses respective distances between corresponding pairs of transactions from among the plurality of transactions as inputs.

16. The computing apparatus of claim 15, wherein the processor is further configured to measure the distance by:
determining, for at least one from among the applied at least one tag and the text associated with the first transaction, a first set of term frequency-inverse document frequency (TF-IDF) vectors;
determining, for the second information, a second set of TF-IDF vectors; and
calculating a cosine distance between the first set of TF-IDF vectors and the second set of TF-IDF vectors.

17. The computing apparatus of claim 15, wherein the processor is further configured to measure the distance by:
extracting, from the first information, a first set of features that includes at least one from among a numeric feature, a categorical feature, and a Boolean feature;
extracting, from the second information, a second set of features that includes at least one from among a numeric feature, a categorical feature, and a Boolean feature; and
calculating a Gower's distance value between the first set of features and the second set of features.

18. The computing apparatus of claim 13, wherein the clustering model includes a density-based spatial clustering of applications with noise (DBSCAN) model.

19. The computing apparatus of claim 11, wherein the processor is further configured to:
determine a total number of transactions within the plurality of transactions;
determine a first number of transactions that are assigned to a subset designated as corresponding to the abnormal transactional behavior group;
determine a second number of transactions that are assigned to a subset designated as corresponding to the anomalous transactional behavior group;
calculate a proportion of a sum of the first number and the second number with respect to the total number of transactions; and
when the calculated proportion exceeds a predetermined threshold, transmit, via the communication interface, a notification message to a user to indicate that a transaction history of the first account requires investigation.

20. The computing apparatus of claim 19, wherein the predetermined threshold is 10%.
